(19) United States
(12) Patent Application Publication
(10) Pub. No.: US 2026/0356680 A1
(43) Pub. Date: Nov. 12, 2026

(54) LITHIUM RICH LAYERED SILICATE AND PROCESS FOR PRODUCING

(71) Applicant: BYK-Chemie GmbH, Wesel (DE)

(72) Inventors: Hussein Kalo, Landshut (DE); Markus Möller, Ottenhofen (DE); Wolfgang Heininger, Moosburg (DE); Sebastian Nettinger, Moosburg (DE); Mustafa Turgut, Moosburg (DE); Detlev Langbehn, München (DE)

(21) Appl. No.: 18/997,323

(22) PCT Filed: Jul. 21, 2023
(86) PCT No.: PCT/EP2023/070363

§ 371 Date: Jan. 21, 2025

(30) Foreign Application Priority Data
Jul. 25, 2022 (EP) 22186713.8

(51) Int. Cl. C01B 33/40; C04B 14/10; C04B 103/00; C09D 1/00

(52) U.S. Cl. CPC C01B 33/40; C04B 14/104; C09D 1/00; C04B 2103/0079

(57) ABSTRACT

The invention relates to process of preparing a modified layered silicate comprising i) Providing a natural layered silicate comprising calcium interlayer cations, ii) Providing a compound having lithium cations and providing a compound having sodium cations, wherein the compounds having lithium cations and the compound having sodium cations are both provided in the form of inorganic salts, and wherein the compound having lithium cations is employed in an amount of 0.3% to 8.0% by weight, calculated on the weight of the natural layered silicate having calcium interlayer cations, iii) Mixing the layered silicate provided in step i) and the compounds provided in step ii) in the presence of water, wherein the water content in the mixture is at least 20% by weight, for a period of at least 5 minutes, iv) Drying the mixture prepared in step iii) to a water content of 15% by weight or less to obtain a modified layered silicate.

The invention relates to a process of preparing a modified layered silicate, to a modified natural silicate, and to the use of the modified natural silicate.

Natural calcium bentonite may be converted to sodium bentonite, termed sodium beneficiation or sodium activation, to exhibit many of sodium bentonite's properties by an ion exchange process. As commonly practiced, this means adding 2-10% of a soluble sodium salt, such as sodium carbonate, to wet calcium bentonite, mixing well, and allowing time for the ion exchange to take place and water to remove the exchanged calcium.

U.S. Pat. No. 3,240,616 relates to a method of activating bentonite clay with an alkali activator solution, comprising applying the solution to the clay prior to mechanical working of the same, drying the clay, and subsequently mechanically milling the activated bentonite clay.

U.S. Pat. No. 6,024,790 describes a process of activating an alkaline earth bentonite swelling clay to an alkali metal bentonite swelling clay with an aqueous activating solution containing an ammonium or alkali metal salt of a sequestering agent selected from phosphonates, hydroxy carboxylic acids, amino carboxylic acids and di- or tri-(or higher) carboxylic acids.

CN 111269606 A describes a process of modifying of a calcium bentonite powder to a sodium bentonite powder. The process comprises treatment of the calcium bentonite with a source of sodium cations in the presence of water, preparation of an aqueous slurry, followed by centrifugation, pH adjustment, and drying.

The known processes provide activated bentonites, which can be used as additives and thickeners in varying compositions. However, the swelling behavior and the ease of exfoliation is not always satisfactory. There is a need to further improve these properties. Furthermore, for use in combination with hydraulic binders, such as in tile adhesives and mortars, it is often necessary to add organic components to provide additional properties. However, such organic components tend to prolong the setting time of the formulations. There is a need to provide layered silicates which reduce the need for organic components in such formulations.

The invention provides a process of preparing a modified layered silicate comprising
i) Providing a natural layered silicate comprising calcium interlayer cations,
ii) Providing a compound having lithium cations and providing a compound having sodium cations, wherein the compounds having lithium cations and the compound having sodium cations are both provided in the form of inorganic salts, and wherein the compound having lithium cations is employed in an amount of 0.3% to 8.0% by weight, calculated on the weight of the natural layered silicate having calcium interlayer cations,
iii) Mixing the layered silicate provided in step i) and the compounds provided in step ii) in the presence of water, wherein the water content in the mixture is at least 20% by weight, for a period of at least 5 minutes, and
iv) Drying the mixture prepared in step iii) to a water content of 15% by weight or less to obtain a modified layered silicate.

The process according to the invention leads to layered silicates having improved swelling behavior and which can be exfoliated easily. This leads to improved thickening properties.

Furthermore, the layered silicates obtained according to the process can be used as additives in hydraulic binders. In this case, the need to employ additional organic additive components is reduced.

In the first step of the process a natural layered silicate comprising calcium interlayer cations is provided. Natural layered silicates are materials which are obtained from clay mines, and which have not been treated or modified, other than by physical methods, such as grinding or sieving to obtain a desired particle size.

In a preferred embodiment, the natural layered silicate has a cation exchange capacity of at least 50 meq/100 g. In preferred embodiments, the cation exchange capacity of the natural layered silicate is at least 60 meq/100 g, more preferably at least 70 meq/100 g. Generally, the cation exchange capacity is at most 180 meq/100 g, preferably at most 150 meq/100 g. In a further preferred embodiment, the cation exchange capacity is in the range of 75 to 140 meq/100 g.

The cation exchange capacity is suitably determined according to DIN EN ISO 11260:2017-04 using barium chloride

In typical embodiments, the natural layered silicate contains at least 5% by weight of Al₂O₃. In preferred embodiments, the natural layered silicate contains at least 10% by weight, more preferably at least 12% by weight of Al₂O₃. Generally, the content of Al₂O₃ is at most 30% by weight, preferably at most 27% by weight. In a further preferred embodiment, the natural layered silicate contains Al₂O₃ in an amount in the range of 15 to 25% by weight.

In preferred embodiments, the natural layered silicate is a smectite clay, more preferably a bentonite clay. The different types of bentonites are each named after the respective dominant cation. For industrial purposes, two main classes of bentonite are recognized: sodium and calcium bentonite. Sodium bentonite is the more valuable, but calcium bentonite is more common. As mentioned above, the naming is based on the dominant interlayer cations. In natural bentonites, other cations than the dominant type, namely Mg and Na cations, are typically present as well. In natural calcium bentonite, the molar ratio of Ca:Mg:Na cations may, for example, vary within the range of 60:25:15 to 80:15:5. Furthermore, natural occurring bentonites are typically not available in high purities. Typically, they carry amounts of inert minerals as impurities in the mineral.

Bentonites are natural clay minerals, wherein the major component is montmorillonite. Generally, bentonites contain montmorillonite in the range of 30 to 90% by weight. The montmorillonites present in bentonites are platelet shaped aluminum-silicates which are stacked on each other. The platelets typically are slightly negatively charged. Therefore, they carry cations in the interlayer between the platelets in order to compensate the negative charges of the layers. Their applications are typically due to their high surface area and platelet like structure which gives them specific advantage in gelling water or solvents or adsorbing specific substances or providing barrier properties. In most of these applications a separation of the platelets into single or small stack platelets is required in order to achieve the best properties. The bentonites can provide this swelling into platelets in case the interlayer cations are single charged, especially if the interlayer cations are sodium or lithium. Bentonite clays which carry mostly divalent cations between their layers as Ca and Mg ions are only slightly swellable and the single platelets of aluminum-silicate cannot be removed from each other in water completely.

In the second step of the process of the invention, a compound having lithium cations and a compound having sodium cations are provided.

The compound having lithium cations can be any lithium salt. Examples of suitable lithium salts are lithium halides, such as lithium chloride or lithium bromide, lithium carbonate, lithium hydrogen carbonate, lithium nitrate, lithium sulfate, lithium hydrogen sulfate, lithium phosphate, lithium hydrogen phosphate, lithium dihydrogen phosphate, lithium formate, lithium acetate, lithium propionate, as well as salts of higher carboxylic acids, lithium citrate, lithium oxalate, as well as lithium salts of sulfonic acids, such as lithium tosylate.

It is preferred that the compound having lithium cations is provided in the form of an inorganic salts. It is also possible to use mixtures of compounds having lithium cations, for examples mixtures of two or more different compounds having lithium cations.

The compound having sodium cations can be any sodium salt. Examples of suitable sodium salts are sodium halides, such as sodium chloride or sodium bromide, sodium carbonate, sodium hydrogen carbonate, sodium nitrate, sodium sulfate, sodium hydrogen sulfate, sodium phosphate, sodium hydrogen phosphate, sodium dihydrogen phosphate, sodium formate, sodium acetate, sodium propionate, as well as salts of higher carboxylic acids, sodium citrate, sodium oxalate, as well as sodium salts of sulfonic acids, such as sodium tosylate.

It is preferred that the compound having sodium cations is provided in the form of an inorganic salts. It is also possible to use mixtures of compounds having sodium cations, for examples mixtures of two or more different compounds having sodium cations.

The compound having lithium cations and the compound having sodium cations are both provided in the form of inorganic salts. In this case, the compound having lithium cations is employed in an amount of 0.3% to 8.0% by weight, more preferably 0.9 to 5.0% by weight, calculated on the weight of the natural layered silicate having calcium interlayer cations, and the compound having sodium cations is preferably employed in an amount of 0.3% to 8.0% by weight, more preferably 0.9 to 5.0% by weight, calculated on the weight of the natural layered silicate having calcium interlayer cations. The amounts of the compound having lithium cations and the compound having sodium cations can be selected independent of each other.

In the third step of the process of the invention, the layered silicate provided in step i) and the compounds provided in step ii) are mixed in the presence of water. The components can be mixed in any suitable order. It is possible to pre-mix the solid components with water individually, and then combine the aqueous mixtures. Alternatively, the solid components can be pre-mixed and added to water, or water can be added to the pre-mixed solid components. In a further embodiment, the compound having sodium cations and the compound having lithium compounds are dissolved in water either individually or together, and the aqueous solution is added to the natural layered silicate.

Water can be used in the form of distilled water, de-ionized water, or tap water.

The water content in the mixture is at least 20% by weight, calculated on the total weight of the mixture. In preferred embodiments, the water content is at least 25% by weight, or at least 30% by weight. Since the major portion of the water is removed later, it is generally preferred that the water content is at most 60% by weight, preferably at most 50% by weight. In particularly preferred embodiments, the water content is in the range of 25 to 45% by weight, calculated on the total weight of the mixture. In embodiments wherein the drying step iv) of the process is carried out by spray drying, the water content of the mixture may also exceed the above-mentioned values. In this case, the water content of the mixture may be 80% by weight, or even 95% by weight. The aqueous mixture generally has the form of an aqueous slurry or of a paste. Mixing can be out using suitable well-known equipment, such as kneaders, blade mixers, or extruders.

Mixing is carried out for a time sufficient to cause some ion exchange reaction of calcium interlayer cations of the natural layered silicate and sodium and lithium cations of the compounds having sodium cations and lithium cations. Generally, mixing is carried out for a period of at least 5 minutes. In typical embodiments, mixing is carried out for a period of at least 10 minutes, preferably at least 15 minutes. Generally, mixing is carried out for a period of at most 120 minutes, preferably at most 90 minutes. In preferred embodiments, mixing is carried out for a period of 20 to 80 minutes.

The mixing step is generally carried out at ambient temperature, for example in a temperature range of 10 °C to 35 °C. If so desired, mixing can also be carried out at elevated temperature, for example in the range of 36 °C to 80 °C. As the mixing process is generally carried out at atmospheric pressure, the temperature during mixing preferably does not exceed the boiling point of water of 100 °C.

In step iv) of the process of the invention, the mixture prepared in step iii) is dried to a water content of 15% by weight or less. The drying step can be carried out immediately after mixing step iii). If so desired, the mixture prepared in step iii) can be allowed to rest for a period of time before drying. That period of time is not particularly limited and is mainly governed by practical consideration of the manufacturing facility, such as the availability of equipment.

In a further embodiment, the mixture is further treated to reduce the particle size prior to drying, for example with a colloid mill or high-pressure homogenizer or with high temperature steam jet.

The drying step can be carried out by any known drying process. Generally, the drying process involves evaporation of water. Evaporation of water can be caused by heating the aqueous mixture in an oven, or by heating while agitating the mixture. In one embodiment, heating and evaporation of water are carried out in an oven. The temperature during can vary in wide ranges. Generally, drying is carried out at temperatures in the range of 60 to 150 °C. If so desired, evaporation of water can be supported by reducing the pressure to below atmospheric pressure. The drying process is carried out for a period sufficient to reduce the water content to a 15% by weight or less. If so desired, the water content can be reduced to 10% by weight or less, 8% by weight or less, or even 5% by weight or less. Water my even be completely removed during the drying process. However, from an economic perspective and in view of energy consumption, is it generally preferred to dry the treated layered silicate to a water content of 0.1% or more by weight of water.

In one embodiment, drying is carried out by spray drying, wherein water is removed from an aqueous slurry by spray drying in a spray drying apparatus to prepare a solid treated layered silicate.

In a still further embodiment, impurities are removed from the aqueous slurry prior to spray drying. The impurities are mainly present in the aqueous slurry in the form of solid particles or incompletely swollen materials, which can be separated from the aqueous phase by physical separation processes, which are generally known to the skilled person. Examples of suitable separation processes include sedimentation, decantation, flotation, and centrifugation. It is also possible to combine such processes or to carry them out in succession, if so desired.

The removed impurities include most of the crystalline impurities and low swellable amorphous minerals and low swellable clays. The impurities to be removed typically comprise at least one of feldspar, calcite, mica, quartz, cristobalite, dolomite, and calcium bentonite.

After the separation step, the aqueous slurry is recovered, and water is removed from the aqueous slurry by spray drying in a spray drying apparatus to prepare the modified natural layered silicate of the invention.

If so desired, it is possible to disperse the modified natural layered silicate of the invention, dried by a method other than spray drying, in water to prepare an aqueous slurry and to remove impurities as explained above, followed by spray drying.

A spray drying apparatus takes a liquid stream and separates the solute or suspension as a solid and the solvent into a vapor. The solid is usually collected in a drum or cyclone. The liquid input stream is sprayed through a nozzle into a hot vapor stream and vaporized. Solids form as moisture quickly leaves the droplets. A nozzle is usually used to make the droplets as small as possible, maximizing heat transfer and the rate of water vaporization. Droplet sizes generally range from 20 to 180 μm depending on the nozzle. There are two main types of nozzles: high pressure single fluid nozzle (50 to 300 bars) and two-fluid nozzles: one fluid is the liquid to dry and the second is compressed gas (generally air at 1 to 7 bars). Instead of atomizing the liquid using a nozzle, a rotary atomizer can be used as well. Rotary atomizers work on the principle of centrifugal energy; this energy is used to produce a high relative speed between the fluid and air which is essential for atomization. A rotary atomizer comprises a rotating surface. This surface can be in the form of a flat or a vane-disc, a cup, or a slotted wheel. The liquid first flows radially outwards in the disc and is then released from the disc's outer limits at a relatively very high speed. The atomization relies on the liquid's flow rate and the disc's rotational speed.

Spray dryers can dry a product very quickly compared to other methods of drying. They also turn a solution (or slurry) into a dried powder in a single step, which simplifies the process.

The inlet air temperature of the spray drying apparatus generally is in the range of 150 to 600 °C, preferably in the range of 200 to 450 °C.

After drying, the modified layered silicate is present in the form of solid particles. If so desired, the process comprises the further step of reducing the particle size of the dried mixture obtained in step iv) by milling or grinding. The additional milling or grinding step is preferably carried out in embodiments, wherein drying was carried out by a method other than spray drying.

In a further embodiment, the process of the invention comprises the further step of adding an inorganic viscosity improving agent to the modified layered silicate. The inorganic viscosity improving agent comprises at least one of calcium hydroxide, calcium oxide, magnesium hydroxide, and magnesium oxide. The inorganic viscosity improving agent can be added before, during or after step iii) of the process. Alternatively, the inorganic viscosity improving agent is added to the modified layered silicate after drying step iv). The inorganic viscosity improving agent is generally added in an amount of the 0.1 to 5.0% by weight, preferably 0.2 to 3.0% by weight, and more preferably 0.3 to 2.5% by weight, calculated on the weight of the modified layered silicate. The inorganic viscosity improving agent may suitable be added in the form of solid particles or as a powder.

The invention further relates to the modified natural silicate which is obtained or obtainable by the process of the invention, hereinafter referred to as the modified natural layered silicate of the invention.

The modified natural layered silicate of the invention comprises sodium and lithium interlayer cations, Al₂O₃ in an amount of at least 5% by weight, and has a cation exchange capacity of at least 50 meq/100 g. In preferred embodiments, the modified natural layered silicate of the invention contains at least 10% by weight, more preferably at least 12% by weight of Al₂O₃. Generally, the content of Al₂O₃ is at most 30% by weight, preferably at most 27% by weight. In a further preferred embodiment, the natural layered silicate contains Al₂O₃ in an amount in the range of 15 to 25% by weight. The content of Al₂O₃ can suitably be determined by dissolving the material in aqua regia (a mixture of nitric acid and hydrochloric acid, optimally in a molar ratio of 1:3), followed by filtration, and analysis of the filtrate by inductively coupled plasma optical emission spectrometry (ICP-OES).

In preferred embodiments, the modified natural layered silicate of the invention has a cation exchange capacity in the range of 60 to 150 meq/100 g, more preferably 65 to 125 meq/100 g.

The modified natural layered silicate of the invention is highly suitable for controlling the rheology of an aqueous composition. In particular, the modified natural layered silicate of the invention can be readily dispersed in numerous aqueous compositions and causes desirable rheological effects. Therefore, the invention also relates to the use of the modified natural layered silicate of the invention for controlling the rheology of an aqueous composition.

The invention further relates to a method of controlling the rheology of an aqueous composition, comprising adding the modified natural layered silicate to an aqueous composition.

In the above-mentioned use or method, the modified natural layered silicate of the invention is suitably added to the aqueous composition in an amount in the range of 0.1 to 7.0%, preferably 0.1 to 5.0% by weight, calculated on the total weight of the aqueous composition.

When the modified natural layered silicate of the invention is added to an aqueous composition, the viscosity of the aqueous composition generally increases. A higher amount of modified natural layered silicate of the invention generally causes a higher increase of the viscosity. In some embodiments, the addition of the modified natural layered silicate of the invention causes a thixotropic behavior of the aqueous composition.

The aqueous composition can be any liquid aqueous composition of which the viscosity should be increased, or which should be rendered thixotropic. Aqueous compositions are those in which the main or only liquid diluent used is water. Preferably, aqueous compositions contain less than 35% by weight, 25% by weight, 20% by weight or even less than 10% by weight of (volatile) organic solvents, based on the total weight of water and organic solvent in the liquid formulation. In some embodiments, aqueous compositions are free of organic solvents. Aqueous compositions may contain water-soluble organic or inorganic compounds, e.g., ionic compounds like salts.

Examples of suitable aqueous liquid compositions include a coating composition, a (pre-) polymer composition, a pigment concentrate, a ceramic product, a sealant, a cosmetic preparation, an adhesive, a casting compound, a lubricant, an ink, a cleaning agent, a liquid for use in gas- or oil production, a putty, a metal working fluid, a sprayable liquid, like deposition aids used for crop protection, a wax emulsion, a liquid for use in energy storage media like batteries, a liquid for use in electric or electronic components, a casting or potting composition, and a building material.

The aqueous compositions which are coating compositions or inks can be used in various application fields, like automotive coatings, construction coatings, protective coatings (like marine or bridge coatings), can and coil coatings, wood and furniture coatings, industrial coatings, plastics coatings, wire enamels, foods and seeds coatings, leather coatings (both for natural and artificial leather), color resists (as used for LC displays). Coating materials include pasty materials which typically have a high content of solids and a low content of liquid components, e.g., pigment pastes or effect pigment pastes (using pigments based on aluminum, silver, brass, zinc, copper, bronzes like gold bronze, iron oxide-aluminum); other examples of effect pigments are interference pigments and pearlescent pigments like metal oxide-mica pigments, bismuth oxide chloride or basic lead carbonate.

The cosmetic compositions can be all kind of aqueous liquid compositions used for personal care and health care purpose. Examples are lotions, creams, pastes like toothpaste, foams like shaving foam, gels like shaving gel and shower gel, pharmaceutical compounds in gel like delivery form, hair shampoo, liquid soap, nail varnish, lipstick, and hair tinting lotions.

Preferred wax emulsions are aqueous dispersions of wax particles formed of waxes which are solid at room temperature.

Spraying agents (preferably used as deposition aids) can be equipped with the modified layered silicate of the invention in order to achieve drift reduction. They may for example contain fertilizers or herbicides, fungicides, and other pesticides.

The formulations used for construction purpose can be materials which are liquid or pasty during handling and processing; these aqueous materials are used in the construction industry and they become solid after setting time, e.g., hydraulic binders like concrete, cement, mortar/plaster, tile adhesives, and gypsum.

Metal working fluids are aqueous compositions used for the treatment of metal and metal parts. Examples are cutting fluids, drilling fluids (used for metal drilling), mold release agents (mostly aqueous emulsions, e.g., in aluminum die casting and foundry applications), foundry washes, foundry coatings, as well as liquids used for the surface treatment of metals (like surface finishing, surface cleaning and galvanization).

Lubricants are aqueous compounds used for lubricating purpose, i.e., used to reduce abrasion and friction loss or to improve cooling, force transmission, vibration damping, sealing effects, and corrosion protection.

Liquid formulations used for gas and oil production are aqueous formulations used to develop and exploit a deposit. Aqueous drilling fluids or “drilling muds” are preferred examples. An application example is hydraulic fracturing.

Cleaners can be used for cleaning different kinds of objects. They support the removal of contaminations, residual dirt and attached debris. Cleaners also include detergents (especially for cleaning textiles, their precursors and leather), cleansers and polishes, laundry formulations, fabric softeners, and personal care products.

Preferred aqueous compositions include an aqueous coating composition, an aqueous composition comprising a hydraulic binder, an aqueous cleaning composition, and an aqueous personal care composition.

The above-mentioned aqueous compositions may comprise other ingredients and additives commonly used in aqueous compositions, for example organic co-solvents, crosslinkers, anti-foaming agents, dispersing aids, and UV stabilizers. Although the modified natural layered silicate of the invention provides excellent thickening properties, it is possible to use it in combination with other rheology control agents, if so desired.

Examples of other rheology control agents include polysaccharides (like cellulose derivatives, guar, xanthan), urea compounds, (poly)amides, polyacrylates (like alkali soluble or swellable emulsions), or associative thickeners (like polyurethane thickeners, aminoplast based thickeners, hydrophobically modified alkali soluble emulsion type thickeners).

The modified natural layered silicate of the invention can also be used as adsorption agent in certain compositions, for example to absorb undesired impurities. In a still further embodiment, the modified natural layered silicate of the invention can be used as a coagulation agent, for example in the treatment of wastewater.

### EXAMPLES

Test methods used to determine the physical and chemical properties of used layered silicate:

The cation exchange capacity was determined according to DIN EN ISO 11260:2017-04 using barium chloride.

Al₂O₃ and Li₂O content in the clay (the chemical analysis of Li/Na-bentonite was done by standard ICP-OES after dissolving the bentonite in aqua regia acid mixture).

Viscosity in water: The Li/Na-bentonite dispersion in water was prepared at 4 wt % of the Li/Na-bentonite mixed in water for 20 minutes. The viscosity was measured after 1 h storing the dispersion in a water bath at 23 °C. The viscosity was measured with a Brookfield rotational viscosimeter at low shear rate at 10 rpm.

The progress of cement hydration was studied by Ultrasound test method using device Ultraschall-Messsystem IP-8 available from Ultra Test GmbH.

### Example 1

A calcium bentonite (Bentonite I) was kneaded in a Werner-Pfleiderer mixer with a mixture of 0.5% by weight of sodium carbonate and 3.0% by weight of lithium carbonate as activator. The mixture of activation agents was dissolved in water and then added to the Ca-bentonite. The water content was adjusted to 35% of the total mixture. The mixture was kneaded for 30 minutes. The treated bentonite was dried at 80 °C and then pulverized.

### Example 1 A

The treated bentonite according to Example 1 was mixed with 1.0% by weight of Ca(OH)₂ as powder.

### Example 2

A calcium bentonite (Bentonite I) was kneaded in a Werner-Pfleiderer mixer with a mixture of 2.5% by weight of sodium carbonate and 2.0% lithium carbonate as activator. The mixture of activation agents was dissolved in water and then added to the Ca-bentonite. The water content was adjusted to 35% of the total mixture. The mixture was kneaded for 30 minutes. The treated bentonite was dried at 80 °C and then pulverized.

### Example 3

A calcium bentonite (Bentonite I) was kneaded in a Werner-Pfleiderer mixer with a mixture of 0.5% by weight of sodium carbonate and 2.5% by weight of lithium carbonate as activator. The mixture of activation agents was dissolved in water and then added to the Ca-bentonite. The water content was adjusted to 35% of the total mixture. The mixture was kneaded for 30 minutes. The treated bentonite was dried at 80 °C and then pulverized.

### Example 4

A calcium bentonite (Bentonite I) was kneaded in a Werner-Pfleiderer mixer with a mixture of 1.0% by weight of Na₃PO₄ and 2.5% by weight of lithium carbonate as activator. The mixture of activation agents were dissolved in water and then added to the Ca-bentonite. The water content was adjusted to 35% of the total mixture. The mixture was kneaded for 30 minutes. The treated bentonite was dried at 80 °C and then pulverized.

### Example 5

A calcium bentonite (Bentonite II) was kneaded in a Werner-Pfleiderer mixer with a mixture of 0.5% by weight of sodium carbonate and 3.0% by weight of lithium carbonate as activator. The mixture of activation agents was dissolved in water and then added to the Ca-bentonite. The water content was adjusted to 35% of the total mixture. The mixture was kneaded for 30 minutes. The treated bentonite was dried at 80 °C and then pulverized.

### Example 6

A calcium bentonite (Bentonite I) was kneaded in a Werner-Pfleiderer mixer with a mixture of 2.5% by weight of sodium citrate dihydrate, 2.0% by weight of lithium carbonate and 3.0% by weight of sodium carbonate as activation mixture. The mixture of activation agents was dissolved in water and then added to the Ca-bentonite. The water content was adjusted to 35% of the total mixture. The mixture was kneaded for 30 minutes. The treated bentonite was dried at 80 °C and then pulverized.

### Example 7

A calcium bentonite (Bentonite I) was kneaded in a Werner-Pfleiderer mixer with a mixture of 5.0% by weight of sodium carbonate and 2.6% by weight of lithium formate monohydrate as activator. The mixture of activation agents was dissolved in water and then added to the Ca-bentonite. The water content was adjusted to 35% of the total mixture. The mixture was kneaded for 30 minutes. The treated bentonite was dried at 80 °C and then pulverized.

### Example 8

A calcium bentonite (Bentonite I) was kneaded in a Werner-Pfleiderer mixer with a mixture of 5.0% by weight of sodium carbonate and 1.9% by weight of lithium oxalate activator. The mixture of activation agents was dissolved in water and then added to the Ca-bentonite. The water content was adjusted to 35% of the total mixture. The mixture was kneaded for 30 minutes. The treated bentonite was dried at 80 °C and then pulverized.

### Example 9

A calcium bentonite (Bentonite I) was kneaded in a Werner-Pfleiderer mixer with a mixture of 2.5% by weight of sodium citrate dihydrate, 1.9% by weight of lithium oxalate and 3.0% by weight of sodium carbonate activator. The mixture of activation agents was dissolved in water and then added to the Ca-bentonite. The water content was adjusted to 35% of the total mixture. The mixture was kneaded for 30 minutes. The treated bentonite was dried at 80 °C and then pulverized.

### Example 10

A calcium bentonite (Bentonite I) was kneaded in a Werner-Pfleiderer mixer with a mixture of 2.0% by weight of sodium carbonate and 3.0% by weight of lithium carbonate activator. The mixture of activation agents was dissolved in water and then added to the Ca-bentonite. The water content was adjusted to 35% of the total mixture. The mixture was kneaded for 30 minutes. The treated bentonite was dried at 80 °C and then pulverized.

### Example 11 (Spray Drying)

The activated bentonite produced via method described in Example 10 was dispersed in deionized water with solid content of 4%. The dispersion was treated with an IKA ULTRA-TURRAX® T 25 with dispersion tool of S25N 18G at speed of 15000 rpm for a period of 10 minutes. The dispersion then centrifuged at 2500 rpm for 10 min. Subsequently, the supernatant dispersion (purified clay phase) was spray dried in Büchi B290 spray dryer.

### Example 12 (Comparative)

A calcium bentonite (Bentonite I) was kneaded in a Werner-Pfleiderer mixer with a 4% sodium carbonate. The activation agent was dissolved in water and then added to the Ca-bentonite. The water content was adjusted to 35% of the total mixture. The mixture was kneaded for 30 minutes. The treated bentonite was dried at 80 °C and then pulverized.

### Example 13 (Comparative/Spray Drying)

The activated bentonite produced via method described in Example 12 was dispersed in deionized water with solid content of 4%. The dispersion was treated with an IKA ULTRA-TURRAX® T 25 with dispersion tool of S25N 18G at speed of 15000 rpm for a period of 10 minutes. The dispersion then centrifuged at 2500 rpm for 10 min. Subsequently, the supernatant dispersion (purified clay phase) was spray dried in Büchi B290 spray dryer.

### Example 14 (Comparative)

A calcium bentonite (Bentonite I) with water content of 5% was mixed with mixture of 2.5% by weight of sodium carbonate and 2.0% by weight of lithium carbonate. The powder mixture was mixed for 30 minutes. The viscosity increasing effect of the powder mixture was measured via the test method mentioned above.

### Example 15 (Comparative)

A calcium bentonite (Bentonite I) was kneaded in a Werner-Pfleiderer mixer with a mixture of 0.45% by weight of sodium carbonate and 0.05% by weight of lithium carbonate as activator. The mixture of activation agents was dissolved in water and then added to the Ca-bentonite. The water content was adjusted to 35% of the total mixture. The mixture was kneaded for 30 minutes. The treated bentonite was dried at 80 °C and then pulverized.

TABLE 1
Chemical composition of used bentonite
types, indicated in % by weight

| | Bentonite I | Bentonite II |
|---|---|---|
| SiO₂ | 52.1 | 62.2 |
| Al₂O₃ | 24.0 | 19.1 |
| MgO | 2.3 | 2.8 |
| CaO | 1.4 | 2.7 |
| Fe₂O₃ | 2.5 | 1.3 |
| Na₂O | 1.3 | 1.0 |
| LOI* | 14.1 | 7.2 |

*LOI means weight loss upon heating to 1000 °C

TABLE 2
Total added activation agent, cation exchange capacity of activated
bentonite, lithium and aluminum oxide content, and measured
Brookfield viscosity of 4 wt % in deionized water.

| | | Brookfield viscosity | | | Cation |
|---|---|---|---|---|---|
| | Total added | of 4 wt % of activated | | | exchange |
| | activation | clay in deionized | | | capacity |
| | agents [%] | water [mPas] | Al₂O₃ [%] | Li₂O [%] | [meq/100 g] |
| Example 1 | 3.5 | 6300 | 23.2 | 1.2 | 102 |
| Example 1 A | 3.5 | 13500 | 23.2 | 1.2 | 102 |
| Example 2 | 4.5 | 4700 | 23.0 | 0.8 | 101 |
| Example 3 | 3.0 | 2900 | 23.3 | 1.0 | 103 |
| Example 4 | 3.5 | 3650 | 23.2 | 1.0 | 100 |
| Example 5 | 3.5 | 4700 | 18.1 | 1.2 | 72 |
| Example 6 | 7.5 | 4320 | 22.3 | 0.8 | 99 |
| Example 7 | 7.6 | 11000 | 22.3 | 1.4 | 99 |
| Example 8 | 6.9 | 9960 | 22.5 | 0.5 | 99 |
| Example 9 | 7.4 | 3500 | 22.4 | 0.5 | 99 |
| Example 10 | 5.0 | 4650 | 22.9 | 1.2 | 101 |
| Example 11 | 5.0 | 18600 | 23.0 | 1.2 | 112 |
| Example 12* | 4.0 | 2850 | 23.0 | 0.0 | 102 |
| Example 14* | 4.5 | 228 | 23.0 | 0.8 | 101 |
| Example 15* | 0.5 | 1 | 23.0 | 0.05 | 102 |

Comparative Examples are marked by *

From Table 2 it can be inferred that the modified natural layered silicates according to the invention cause a higher viscosity increase in water than the comparative layered silicates of Examples 12, 14, and 15. The layered silicate of Comparative Example 12 was activated with sodium cations only. This leads to a lower viscosity increasing effect in water than the layered silicates according to the invention. In comparative Example 14 no water was added during the treatment of the natural layered silicate. As a consequence, no interlayer cations were exchanged. Comparative Example 15 was activated with a too low amount of lithium ions. The result is an absent thickening effect.

### Preparation of Cementitious Compositions

### Example C1

The mortar according to the composition in Table 3 was mixed using a basket agitator at 750 rpm for 2 minutes. The mixed mortar was filled in an ultrasound cell for measuring the cement hydration progress.

TABLE 3

| | % by weight |
|---|---|
| Cement (55.2R premium) | 32.76 |
| Sand (GS 21) | 43.10 |
| Water | 24.14 |

### Example C2

The mortar according to the composition in Table 4 was mixed using a basket agitator at 750 rpm for 2 minutes. The activated Li/Na-Bentonite according to Example 1 was used. The mixed mortar was filled in an ultrasound cell for measuring the cement hydration progress.

TABLE 4

| | % by weight |
|---|---|
| Li/Na-bentonite (Example 1) | 0.18 |
| Cement (55.2R premium) | 33.66 |
| Sand (GS 21) | 44.29 |
| Water | 21.87 |

### Example C3

The influence of combination the Li/Na-bentonite and organic rheology modifier (starch ether) on cement hydration progress was studied. The mortar according to the composition in Table 5 was mixed using a basket agitator at 750 rpm for 2 minutes. The activated Li/Na-Bentonite according to Example 2 was used. The mixed mortar was filled in an ultrasound cell for measuring the cement hydration progress.

TABLE 5

| | % by weight |
|---|---|
| Modified layered silicate of Example 1 | 0.18 |
| Cement (55.2R premium) | 33.65 |
| Sand (GS 21) | 44.27 |
| Organic rheology modifier (starch ether) | 0.03 |
| Water | 21.87 |

### Example C4 (Comparative Example)

Example C3 was repeated using 4% soda activated bentonite instead of Li/Na-bentonite. The mortar composition is listed in Table 6.

TABLE 6

| | % by weight |
|---|---|
| Comparative layered silicate of Example 12 | 0.18 |
| Cement (55.2R premium) | 33.65 |
| Sand (GS 21) | 44.27 |
| Organic rheology modifier (starch ether) | 0.03 |
| Water | 21.87 |

In Table 7 the results of cement hydration of Examples C1-C4 are listed. The velocity values are presenting solidification progress of the mortar mixtures. The velocity values of mortar mixtures hardening are compared at 800, 1300 and 1600 minutes after preparation. Higher values of velocity indicate a higher mortar solidification. The Li/Na modified layered silicate present in mortar composition C2 is increasing the speed of mortar solidification, as compared to Example C1 without any added layered silicate. Examples C3 and C4 both contain an organic rheology modifier, which causes an expected delay of mortar solidification. Also in this case, the addition of a modified layered silicate of the invention in C3 causes a better mortar solidification than the addition of a comparative sodium-only modified layered silicate in mortar C4.

TABLE 7

Velocity [m/s]

| | @ 800 min | @ 1300 min | @ 1600 min |
|---|---|---|---|
| Sample | setting time | setting time | setting time |
| Example C1 | 250 | 1000 | 1650 |
| Example C2 | 400 | 1375 | 1850 |
| Example C3 | 200 | 850 | 1400 |
| Example C4 | 175 | 600 | 1100 |

Paint formulations were prepared as summarized in Table 8 below. The amounts of components are indicated in parts by weight.

TABLE 8

| High-filled white paint | | |
|---|---|---|
| based on vinyl ethylene | | +0.5% modified |
| acetate VEA dispersion | control | layered silicate |
| Dest. water | 27.75 | 27.75 |
| Acticide MBS | 0.2 | 0.2 |
| BYK 1640 (BYK Chemie GmbH) | 0.2 | 0.2 |
| Disperbyk-199 (BYK Chemie GmbH) | 0.5 | 0.5 |
| NaOH 10% in water | 0.25 | 0.25 |
| Kronos 2190 | 18.0 | 18.0 |
| Omyacarb 5GU | 22.0 | 22.0 |
| Omyacarb 2GU | 11.0 | 11.0 |
| Dispersion: Dissolver: 5 min, | | |
| 8500 rpm. 4 cm | | |
| Modified layered silicate | — | 0.5 |
| as shown in Table 9 | | |
| Dispersion: Dissolver: 15 min, | | |
| 8500 rpm. 4 cm | | |
| Letdown | | |
| Vinnapas EP 3888 (Wacker Chemie AG) | 20.0 | 20.0 |
| BYK 1640 (BYK Chemie GmbH) | 0.1 | 0.1 |
| Add while stirring | | |
| Dispersion: Dissolver: 5 min, | | |
| 1500 rpm. 4 cm | | |
| | 100.0 | 100.5 |

The paint formulations were applied with a stepped doctor blade Model 421/S (Erichsen GmbH & Co KG) with 50-500 and 550-1000 μm wet film thickness. The application was done on contrast cards 2801 (BYK-Gardner GmbH) using the automatic applicator byko-drive XL (BYK-Gardner GmbH) with an application speed of 50 mm/s. Directly after application the draw down was hanged up vertical at room temperature until it was dried. After drying the sag resistance was evaluated visually. Table 9 indicates the highest wet film thickness in μm without runner and bulge formation.

Viscosity curves were measured with a rheometer Physica MCR 301 (Anton Paar). In Table 9 viscosity (Pa·s) is recorded at different shear rates (1/s), both with ascending and descending shear rate.

TABLE 9
Results of the tested material in paint formulation

| | | Ascending shear rate | | Descending shear rate | | |
|---|---|---|---|---|---|---|
| | Sag | Viscosity | Viscosity | Viscosity | Viscosity | Viscosity |
| | resistance | at 0.4 1/s | at 10 1/s | at 10 1/s | at 0.4 1/s | at 0.1 1/s |
| | (μm) | (Pa · s) | (Pa · s) | (Pa · s) | (Pa · s) | (Pa · s) |
| Control | 50 | 280 | 14 | 10 | 278 | 932 |
| Example 11 | 600 | 1251 | 54 | 44 | 921 | 3212 |
| Example 13* | 300 | 956 | 42 | 35 | 714 | 2388 |

*Comparative Example

From Table 9 it can be inferred that modified layered silicate according to the invention of Example 11 leads to a higher viscosity and a better sag resistance of a white paint than the comparative layered silicate of comparative Example 13, which was activated with sodium ions only.

1. A process of preparing a modified layered silicate comprising
i) Providing a natural layered silicate comprising calcium interlayer cations,
ii) Providing a compound having lithium cations and providing a compound having sodium cations, wherein the compounds having lithium cations and the compound having sodium cations are both provided in the form of inorganic salts, and wherein the compound having lithium cations is employed in an amount of 0.3% to 8.0% by weight, calculated on the weight of the natural layered silicate having calcium interlayer cations,
iii) Mixing the layered silicate provided in step i) and the compounds provided in step ii) in the presence of water, wherein the water content in the mixture is at least 20% by weight, for a period of at least 5 minutes,
iv) Drying the mixture prepared in step iii) to a water content of 15% by weight or less to obtain a modified layered silicate.

2. The process according to claim 1, wherein the natural layered silicate has a cation exchange capacity of at least 50 meq/100 g.

3. The process according to claim 1, wherein the natural layered silicate contains at least 5% by weight of Al₂O₃.

4. The process according to claim 1, wherein the natural layered silicate is a smectite.

5. The process according to claim 1, wherein the natural layered silicate is a bentonite.

6. The process according to claim 1, wherein the compound having lithium cations is employed in an amount of 0.9% to 5.0% by weight, calculated on the weight of the natural layered silicate having calcium interlayer cations, and wherein the compound having sodium cations is employed in an amount of 0.3% to 8.0% by weight, calculated on the weight of the natural layered silicate having calcium interlayer cations.

7. The process according to claim 1, wherein step iv) is carried out by spray drying.

8. The process according to claim 1, wherein the process comprises the further step of reducing the particle size of the dried mixture obtained in step iv) by milling or grinding.

9. A modified natural layered silicate, obtainable by a process according to claim 1, wherein the modified layered silicate comprises sodium and lithium interlayer cations, Al₂O₃ in an amount of at least 5% by weight, and has a cation exchange capacity of at least 50 meq/100 g.

10. (canceled)

11. The method according to claim 13, wherein the aqueous composition is an aqueous coating composition.

12. The method according to claim 13, wherein the aqueous composition comprises a hydraulic binder.

13. A method of modifying the rheology of an aqueous composition comprising adding the modified layered silicate according to claim 9 to an aqueous composition.
